(19) United States
(12) Patent Application Publication
(10) Pub. No.: US 2025/0390407 A1
(43) Pub. Date: Dec. 25, 2025

(54) SYSTEMS AND METHODS FOR POWER DOMAIN POWER COUPLING DETERMINATION OF CONDITIONAL ENABLEMENT

(71) Applicant: Dell Products L.P., Round Rock, TX (US)

(72) Inventors: Jeffrey L. KENNEDY, Austin, TX (US); Timothy M. LAMBERT, Austin, TX (US); Jonathan F. LEWIS, Austin, TX (US)

(73) Assignee: Dell Products L.P., Round Rock, TX (US)

(21) Appl. No.: 18/751,714

(22) Filed: Jun. 24, 2024

(51) Int. Cl. G06F 11/30

(52) U.S. Cl. CPC G06F 11/3093; G06F 11/3041

(57) ABSTRACT

In an information handling system comprising a host system, an information handling resource coupled to the host system and comprising a main power path via a card electromechanical connector and an auxiliary power path via a cable connector, and a management controller coupled to the host system and the information handling resource and configured, a method may include, by the management controller: observing, via a primary function of a card cable presence detection signal of the information handling resource, an indication that the auxiliary power path is coupled to a source of electrical energy via a cable; responsive to observing the card cable presence detection signal, communicating a stimulus to the information handling resource via a secondary function of the card cable presence detection signal; and querying an input/output interface of the information handling resource to determine a response of the information handling resource to the stimulus.

### TECHNICAL FIELD

The present disclosure relates in general to information handling systems, and more particularly to methods and systems for determination of power domain coupling and conditional enablement.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Oftentimes, peripheral information handling resources, such as Smart network interface cards (SmartNICs), data processing units (DPUs), and infrastructure processing units (IPUs), require power delivery above what may be supplied through a Peripheral Component Interconnect Express (PCIe) card electromechanical (CEM) connector which necessitates an auxiliary power cable connection to the device.

Some of such peripheral information handling resources are capable of operating completely independently from a host system processor of an information handling system in which the power state of the host system is decoupled from that of the peripheral information handling resource. For example, a DPU may function with its own operating system and computing cores with access to networking and storage devices while the host processor is off. Another example is removal of power from a graphics processing unit (GPU) to save idle power in an unutilized resource.

In existing approaches, card designers have not had to account for cable and CEM power domains to be separate, as traditional designs have been designed for both paths to both be on or off. Accordingly, there are no protections presently in place to prevent damage if one power domain is enabled while the other is not. Such protections may be thus be needed at the system level to prevent accidental asynchronous power domain enablement.

### SUMMARY

In accordance with the teachings of the present disclosure, the disadvantages and problems associated with existing approaches for managing different power domains in a peripheral information handling resource may be reduced or eliminated.

In accordance with embodiments of the present disclosure, an information handling system may include a host system, an information handling resource communicatively coupled to the host system, the information handling resource comprising a main power path via a card electromechanical connector and an auxiliary power path via a cable connector, and a management controller communicatively coupled to the host system and the information handling resource and configured to provide management facilities for management of the host system. The management controller may be further configured to: observe, via a primary function of a card cable presence detection signal of the information handling resource, an indication that the auxiliary power path is coupled to a source of electrical energy via a cable; responsive to observing the card cable presence detection signal, communicate a stimulus to the information handling resource via a secondary function of the card cable presence detection signal; and query an input/output interface of the information handling resource to determine a response of the information handling resource to the stimulus.

In accordance with these and other embodiments of the present disclosure, a method may be provided for an information handling system comprising a host system, an information handling resource communicatively coupled to the host system and comprising a main power path via a card electromechanical connector and an auxiliary power path via a cable connector, and a management controller communicatively coupled to the host system and the information handling resource and configured to provide management facilities for management of the host system. The method may include, by the management controller: observing, via a primary function of a card cable presence detection signal of the information handling resource, an indication that the auxiliary power path is coupled to a source of electrical energy via a cable; responsive to observing the card cable presence detection signal, communicating a stimulus to the information handling resource via a secondary function of the card cable presence detection signal; and querying an input/output interface of the information handling resource to determine a response of the information handling resource to the stimulus.

In accordance with these and other embodiments of the present disclosure, an article of manufacture may include a non-transitory computer-readable medium and computer-executable instructions carried on the computer-readable medium, the instructions readable by a processor, the instructions, when read and executed, for causing the processor to, in a management controller of an information handling system comprising a host system, an information handling resource communicatively coupled to the host system and comprising a main power path via a card electromechanical connector and an auxiliary power path via a cable connector, and the management controller communicatively coupled to the host system and the information handling resource and configured to provide management facilities for management of the host system: observe, via a primary function of a card cable presence detection signal of the information handling resource, an indication that the auxiliary power path is coupled to a source of electrical energy via a cable; responsive to observing the card cable presence detection signal, communicate a stimulus to the information handling resource via a secondary function of the card cable presence detection signal; and query an input/output interface of the information handling resource to determine a response of the information handling resource to the stimulus.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example information handling system, in accordance with embodiments of the present disclosure; and

FIG. 2 illustrates a flow chart of an example method for determination of power domain power coupling and conditional enablement of information handling resources, in accordance with embodiments of the present disclosure.

### DETAILED DESCRIPTION

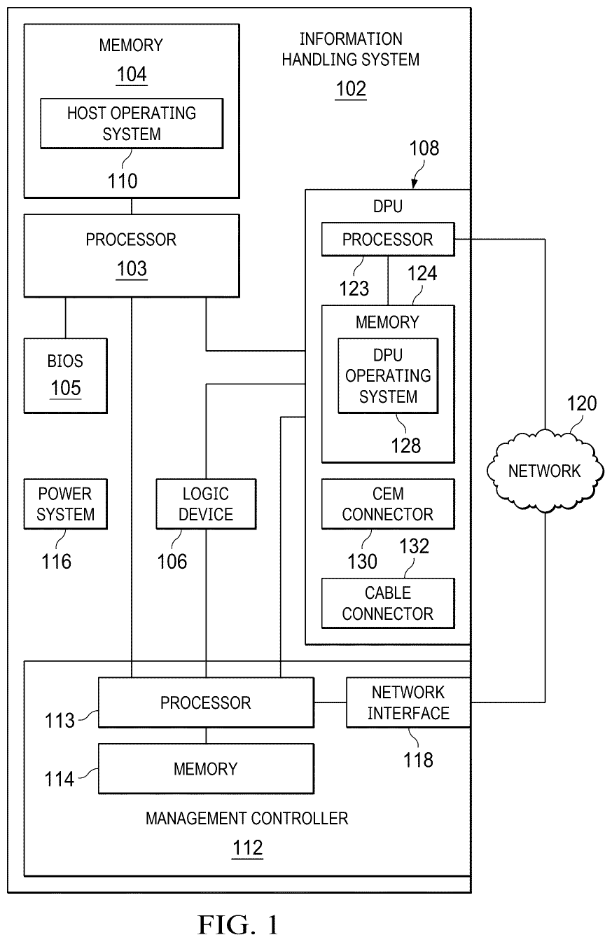

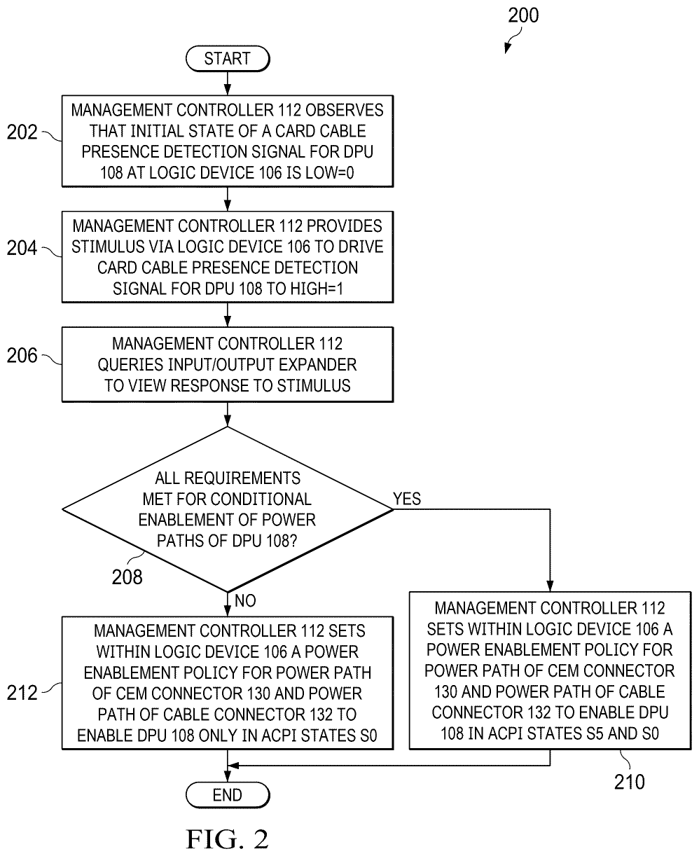

Preferred embodiments and their advantages are best understood by reference to FIGS. 1 and 2, wherein like numbers are used to indicate like and corresponding parts.

For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as communications media such as wires, optical fibers, microwaves, radio waves, and other electromagnetic and/or optical carriers; and/or any combination of the foregoing.

For the purposes of this disclosure, information handling resources may broadly refer to any component system, device or apparatus of an information handling system, including without limitation processors, service processors, basic input/output systems, buses, memories, I/O devices and/or interfaces, storage resources, network interfaces, motherboards, and/or any other components and/or elements of an information handling system.

FIG. 1 illustrates a block diagram of an example information handling system 102, in accordance with embodiments of the present disclosure. In some embodiments, information handling system 102 may comprise or be an integral part of a server. In other embodiments, information handling system 102 may be a personal computer. In these and other embodiments, information handling system 102 may be a portable information handling system (e.g., a laptop, notebook, tablet, handheld, smart phone, personal digital assistant, etc.). As depicted in FIG. 1, information handling system 102 may include a processor 103, a memory 104 communicatively coupled to processor 103, a basic input/output (BIOS) system 105 communicatively coupled to processor 103, a logic device 106 communicatively coupled to management controller 112, a data processing unit (DPU) 108 communicatively coupled to processor 103, a management controller 112 communicatively coupled to processor 103 and DPU 108, and a power system 116 configured to distribute electrical energy to components of information handling system 102.

Processor 103 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in memory 104 and/or another component of information handling system 102.

Memory 104 may be communicatively coupled to processor 103 and may include any system, device, or apparatus configured to retain program instructions and/or data for a period of time (e.g., computer-readable media). Memory 104 may include RAM, EEPROM, a PCMCIA card, flash memory, magnetic storage, opto-magnetic storage, or any suitable selection and/or array of volatile or non-volatile memory that retains data after power to information handling system 102 is turned off.

As shown in FIG. 1, memory 104 may have stored thereon a host operating system 110. Host operating system 110 may comprise any program of executable instructions, or aggregation of programs of executable instructions, configured to, when executed by processor 103, manage and/or control the allocation and usage of hardware resources of information handling system 102 such as memory, processor time, disk space, and input and output devices, and provide an interface between such hardware resources and application programs hosted by host operating system 110.

BIOS 105 may be communicatively coupled to processor 103 and may include any system, device, or apparatus configured to identify, test, and/or initialize information handling resources of information handling system 102. “BIOS” may broadly refer to any system, device, or apparatus configured to perform such functionality, including without limitation, a Unified Extensible Firmware Interface (UEFI). In some embodiments, BIOS 105 may be implemented as a program of instructions that may be read by and executed on processor 103 to carry out the functionality of BIOS 105. In these and other embodiments, BIOS 105 may comprise boot firmware configured to be the first code executed by processor 103 when information handling system 102 is booted and/or powered on. As part of its initialization functionality, code for BIOS 105 may be configured to set components of information handling system 102 into a known state, so that one or more applications (e.g., an operating system or other application programs) stored on compatible media (e.g., memory 104) may be executed by processor 103 and given control of information handling system 102.

Logic device 106 may comprise any suitable system, device, or apparatus that may perform a specialized function that extends the functionality of information handling system 102. For example, logic device 106 may serve as an interface between management controller 112 and subsystems of information handling system 102 for communication of control information associated with such subsystems. In some embodiments, logic device 106 may comprise a complex programmable logic device (CPLD) or a field-programmable gate array (FPGA).

DPU 108 may comprise any suitable system, apparatus, or device that comprises a specialized card or other peripheral with its own processor, local storage, and operating system stored on such local storage, and may in essence function itself as an information handling system. In some embodiments, DPU 108 may also be known as a smartNIC, infrastructure processing unit (IPU), functional accelerator card (FAC), functional off-load coprocessor (FOCP), or distributed services card (DSC). As shown in FIG. 1, DPU 108 may comprise a processor 123, a memory 124, a card electromechanical (CEM) connector 130, and a cable connector 132.

Processor 123 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 123 may interpret and/or execute program instructions and/or process data stored in memory 124 and/or another component of DPU 108.

Memory 124 may be communicatively coupled to processor 123 and may include any system, device, or apparatus configured to retain program instructions and/or data for a period of time (e.g., computer-readable media). Memory 124 may include RAM, EEPROM, a PCMCIA card, flash memory, magnetic storage, opto-magnetic storage, or any suitable selection and/or array of volatile or non-volatile memory that retains data after power to DPU 108 is turned off.

As shown in FIG. 1, memory 124 may have stored thereon a DPU operating system 128. DPU operating system 128 may comprise any program of executable instructions, or aggregation of programs of executable instructions, configured to, when executed by processor 123, manage and/or control the allocation and usage of hardware resources of DPU 108 such as memory, processor time, disk space, and input and output devices, and provide an interface between such hardware resources and application programs hosted by DPU operating system 128.

CEM connector 130 may comprise any suitable system, device, or apparatus configured to mechanically and electrically couple DPU 108 to a circuit board (e.g., a motherboard) in order to enable communication of data between DPU 108 and any one or more of processor 103, management controller 112, and logic device 106, and in order to enable delivery of electrical energy from power system 116 to DPU 108. For example, CEM connector 130 may comprise an edge connector configured to engage with a corresponding receptacle connector of the circuit board. For purposes of clarity and exposition, such circuit board and receptacle connector are not depicted in FIG. 1.

Cable connector 132 may comprise any suitable system, device, or apparatus configured to mechanically and electrically couple a cable to DPU 108. Such cable may couple at its other end to a circuit board (e.g., a motherboard) and may enable delivery of electrical energy from power system 116 to DPU 108. For example, coupling of a cable to cable connector 132 may allow DPU 108 to draw additional auxiliary power, as power available via CEM connector 130 may not be sufficient to power DPU 108. In some embodiments, cable connector 132 and a cable coupled thereto may also be configured to communicate data between DPU 108 and any one or more of processor 103, management controller 112, and logic device 106. For purposes of clarity and exposition, the cable coupled to cable connector 132 is not depicted in FIG. 1.

Management controller 112 may be configured to provide out-of-band management facilities for management of information handling system 102. Such management may be made by management controller 112 even if information handling system 102 is powered off or powered to a standby state. Management controller 112 may include a processor 113, memory 114, and an out-of-band network interface 118 separate from and physically isolated from an in-band network interface (e.g., DPU 108). In certain embodiments, management controller 112 may include or may be an integral part of a baseboard management controller (BMC), a remote access controller (e.g., a Dell Remote Access Controller or Integrated Dell Remote Access Controller), or an enclosure controller. In other embodiments, management controller 112 may include or may be an integral part of a chassis management controller (CMC).

Processor 113 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 113 may interpret and/or execute program instructions and/or process data stored in memory 114 and/or another component of information handling system 102 or management controller 112.

Memory 114 may be communicatively coupled to processor 113 and may include any system, device, or apparatus configured to retain program instructions and/or data for a period of time (e.g., computer-readable media). Memory 114 may include RAM, EEPROM, a PCMCIA card, flash memory, magnetic storage, opto-magnetic storage, or any suitable selection and/or array of volatile or non-volatile memory that retains data after power to management controller 112 is turned off. Memory 114 may have stored thereon software and/or firmware which may be read and executed by processor 113 for carrying out the functionality of management controller 112.

Network interface 118 may comprise any suitable system, apparatus, or device operable to serve as an interface between management controller 112 and/or one or more other information handling systems. Network interface 118 may enable management controller 112 to communicate using any suitable transmission protocol and/or standard. In these and other embodiments, network interface 118 may comprise a network interface card, or “NIC.”

Generally speaking, power system 116 may include any system, device, or apparatus configured to supply electrical current to one or more information handling resources of information handling system 102. Accordingly, power system 116 may include one or more power supply units, one or more voltage regulators, and/or other components. In some embodiments, power system 116 may include one or more programmable components (e.g., a programmable voltage regulator). For purposes of clarity and exposition, the connectivity of power system 116 to various components of information handling system 102 is not depicted in FIG. 1. However, it is understood that power system 116 may be coupled to components of information handling system 102 in any suitable manner in order to provide electrical energy to such other components.

In addition to processor 103, memory 104, BIOS 105, logic device 106, DPU 108, management controller 112, and power system 116, information handling system 102 may include one or more other information handling resources.

Network 120 may comprise a network and/or fabric configured to couple information handling system 102 to one or more other information handling systems. In these and other embodiments, network 120 may include a communication infrastructure, which provides physical connections, and a management layer, which organizes the physical connections and information handling systems communicatively coupled to network 120. Network 120 may be implemented as, or may be a part of, a storage area network (SAN), personal area network (PAN), local area network (LAN), a metropolitan area network (MAN), a wide area network (WAN), a wireless local area network (WLAN), a virtual private network (VPN), an intranet, the Internet or any other appropriate architecture or system that facilitates the communication of signals, data and/or messages (generally referred to as data). Network 120 may transmit data via wireless transmissions and/or wire-line transmissions using any storage and/or communication protocol, including without limitation, Fibre Channel, Frame Relay, Asynchronous Transfer Mode (ATM), Internet protocol (IP), other packet-based protocol, small computer system interface (SCSI), Internet SCSI (iSCSI), Serial Attached SCSI (SAS) or any other transport that operates with the SCSI protocol, advanced technology attachment (ATA), serial ATA (SATA), advanced technology attachment packet interface (ATAPI), serial storage architecture (SSA), integrated drive electronics (IDE), and/or any combination thereof. Network 120 and its various components may be implemented using hardware, software, or any combination thereof.

In operation, management controller 112 may be configured to communicate with DPU 108 via a sideband interface. Such sideband interface may enable the communication of control and management signals between management controller 112 and DPU 108 (e.g., via logic device 106). In some instances, such communication may occur even when the host system (e.g., processor 103, memory 104, etc.) of information handling system 102 is powered down (e.g., in state S5 of the Advanced Configuration and Power Interface (ACPI) standard). In some embodiments, such sideband interface may be in accordance with a Peripheral Component Interconnect Special Interest Group (PCI-SIG) standard (e.g., PCI-SIG base specification).

One of such sideband signals between management controller 112 and DPU 108 may comprise a cable presence detection signal for DPU 108 (e.g., signal CARD_CBL_PRES #of the PCI-SIG base specification). In accordance with the PCI-SIG base specification, such cable presence detection signal may have a primary function of providing a signal from DPU 108 to power system 116 that DPU 108 has detected that a cable is correctly attached to cable connector 132. Under the PCI-SIG standard, add-in cards such as DPU 108 are required to support this primary function.

In accordance with the PCI-SIG base specification, such cable presence detection signal may have a secondary function of providing a signal from power system 116 to DPU 108 to be detected and presented to the power budgeting sense detect register. Such function is for the purpose of allowing information handling system 102 to correlate which system/power cable source is coupled to which connector on a specific PCIe card slot. Under the PCI-SIG standard, add-in cards such as DPU 108 are not required to support this secondary function.

The secondary function response to a system stimulus may only be observable in the PCIe configuration space. The intent of the secondary function is that it is necessary for power budgeting only and requires BIOS 105 to validate the source to destination couplings. While the secondary function itself is not intended by the standard to validate couplings in order to conditionally enable cabled power paths during ACPI S5, in accordance with systems and methods of the present disclosure, DPU 108 may include a circuit addition that enables management controller 112 discovery of couplings independent of the power state of the host system of information handling system 102.

In other words, the methods and systems disclosed herein may use the secondary function of a card cable presence detection signal in a manner that enables detection of electrical coupling independent of the host system of information handling system 102, thus allowing positive identification and correlation of CEM and cabled power paths to a single device. Further, the methods and systems disclosed herein provide for orchestration between management controller 112 and logic device 106 to conditionally enable the CEM and cabled power paths simultaneously independent of the power state of the host system of information handling system 102.

FIG. 2 illustrates a flow chart of an example method 200 for determination of power domain power coupling and conditional enablement of information handling resources, in accordance with embodiments of the present disclosure. According to some embodiments, method 200 may begin at step 202. As noted above, teachings of the present disclosure may be implemented in a variety of configurations of information handling system 102. As such, the preferred initialization point for method 200 and the order of the steps comprising method 200 may depend on the implementation chosen.

At step 202, management controller 112 may observe that the initial state of a card cable presence detection signal (e.g., CARD_CBL_PRES #) for DPU 108 at logic device 106 is low=0, indicating that a cable is connected to cable connector 132. At step 204, management controller 112 may provide a stimulus, via logic device 106, to drive the card cable presence detection signal (e.g., CARD_CBL_PRES #) for DPU 108 to high=1.

At step 206, management controller 112 may query an input/output expander (e.g., a System Management Bus (SMBus) input/output expander) to view the response to the stimulus. At step 208, management controller 112 may determine if all requirements are met for conditional enablement of the power paths of DPU 108. Examples of such requirements may include, without limitation:
device class/type is such that power enablement during ACPI S5 is required for full functionality;
cabled path has been identified to be coupled to a singular device at the CEM slot location of said device class;
system level thermal/fan controls are available in. ACPI S5 to the zone which is occupied by DPU 108; and/or.
power gating for both the cabled and CEM paths during ACPI S5 are present such that they can be simultaneously enabled by firwmare policy and hardware control.

If all requirements are met, method 200 may proceed to step 210. Otherwise, method 200 may proceed to step 212.

At step 210, in response to a determination that all requirements for conditional enablement of the power paths of DPU 108 have been met, management controller 112 may set within logic device 106 a power enablement policy for the power path of CEM connector 130 and the power path of cable connector 132 to enable DPU 108 in ACPI states S5 and S0. After completion of step 210, method 200 may end as to DPU 108, but may be repeated for other information handling resources (e.g., add-in cards) of information handling system 102.

At step 212, in response to a determination that not all requirements for conditional enablement of the power paths of DPU 108 have been met, management controller 112 may set within logic device 106 a power enablement policy for the power path of CEM connector 130 and the power path of cable connector 132 to enable DPU 108 only in ACPI state S0. After completion of step 212, method 200 may end as to DPU 108, but may be repeated for other information handling resources (e.g., add-in cards) of information handling system.

Although FIG. 2 discloses a particular number of steps to be taken with respect to method 200, method 200 may be executed with greater or fewer steps than those depicted in FIG. 2. In addition, although FIG. 2 discloses a certain order of steps to be taken with respect to method 200, the steps comprising method 200 may be completed in any suitable order.

Method 200 may be implemented in whole or part using information handling system 102 and/or any other system operable to implement method 200. In certain embodiments, method 200 may be implemented partially or fully in software and/or firmware embodied in computer-readable media.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative. Accordingly, modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described above.

Unless otherwise specifically noted, articles depicted in the drawings are not necessarily drawn to scale.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

Although specific advantages have been enumerated above, various embodiments may include some, none, or all of the enumerated advantages. Additionally, other technical advantages may become readily apparent to one of ordinary skill in the art after review of the foregoing figures and description.

To aid the Patent Office and any readers of any patent issued on this application in interpreting the claims appended hereto, applicants wish to note that they do not intend any of the appended claims or claim elements to invoke 35 U.S.C. § 112(f) unless the words “means for” or “step for” are explicitly used in the particular claim.

What is claimed is:

1. An information handling system comprising:
a host system;
an information handling resource communicatively coupled to the host system, the information handling resource comprising a main power path via a card electromechanical connector and an auxiliary power path via a cable connector; and
a management controller communicatively coupled to the host system and the information handling resource and configured to provide management facilities for management of the host system, the management controller further configured to:
observe, via a primary function of a card cable presence detection signal of the information handling resource, an indication that the auxiliary power path is coupled to a source of electrical energy via a cable;
responsive to observing the card cable presence detection signal, communicate a stimulus to the information handling resource via a secondary function of the card cable presence detection signal; and
query an input/output interface of the information handling resource to determine a response of the information handling resource to the stimulus.

2. The information handling system of claim 1, wherein the management controller is further configured to:
determine if requirements for conditional enablement of power paths of the information handling resource are satisfied; and
if the requirements are satisfied, set a power enablement policy for the main power path and the auxiliary power path to enable the information handling resource in both a powered on state and a powered off state of the host system.

3. The information handling system of claim 2, wherein the management controller is further configured to, if the requirements are unsatisfied, set a power enablement policy for the main power path and the auxiliary power path to enable the information handling resource in only the powered on state of the host system.

4. The information handling system of claim 1, wherein the information handling resource comprises a data processing unit.

5. The information handling system of claim 1, wherein the card cable presence detection signal comprises CARD_CBL_PRES #of the Peripheral Component Interconnect Special Interest Group standard.

6. The information handling system of claim 1, wherein the input/output interface is a System Management Bus input/output expander.

7. A method, in an information handling system comprising a host system, an information handling resource communicatively coupled to the host system and comprising a main power path via a card electromechanical connector and an auxiliary power path via a cable connector, and a management controller communicatively coupled to the host system and the information handling resource and configured to provide management facilities for management of the host system, the method comprising, by the management controller:
observing, via a primary function of a card cable presence detection signal of the information handling resource, an indication that the auxiliary power path is coupled to a source of electrical energy via a cable;
responsive to observing the card cable presence detection signal, communicating a stimulus to the information handling resource via a secondary function of the card cable presence detection signal; and
querying an input/output interface of the information handling resource to determine a response of the information handling resource to the stimulus.

8. The method of claim 7, further comprising, by the management controller:
determining if requirements for conditional enablement of power paths of the information handling resource are satisfied; and
if the requirements are satisfied, setting a power enablement policy for the main power path and the auxiliary power path to enable the information handling resource in both a powered on state and a powered off state of the host system.

9. The method of claim 8, further comprising, by the management controller, if the requirements are unsatisfied, setting a power enablement policy for the main power path and the auxiliary power path to enable the information handling resource in only the powered on state of the host system.

10. The method of claim 7, wherein the information handling resource comprises a data processing unit.

11. The method of claim 7, wherein the card cable presence detection signal comprises CARD_CBL_PRES #of the Peripheral Component Interconnect Special Interest Group standard.

12. The method of claim 7, wherein the input/output interface is a System Management Bus input/output expander.

13. An article of manufacture comprising:
a non-transitory computer-readable medium; and
computer-executable instructions carried on the computer-readable medium, the instructions readable by a processor, the instructions, when read and executed, for causing the processor to, in a management controller of an information handling system comprising a host system, an information handling resource communicatively coupled to the host system and comprising a main power path via a card electromechanical connector and an auxiliary power path via a cable connector, and the management controller communicatively coupled to the host system and the information handling resource and configured to provide management facilities for management of the host system:
observe, via a primary function of a card cable presence detection signal of the information handling resource, an indication that the auxiliary power path is coupled to a source of electrical energy via a cable;
responsive to observing the card cable presence detection signal, communicate a stimulus to the information handling resource via a secondary function of the card cable presence detection signal; and
query an input/output interface of the information handling resource to determine a response of the information handling resource to the stimulus.

14. The article of claim 13, the instructions for further causing the processor to, in the management controller:
determine if requirements for conditional enablement of power paths of the information handling resource are satisfied; and
if the requirements are satisfied, set a power enablement policy for the main power path and the auxiliary power path to enable the information handling resource in both a powered on state and a powered off state of the host system.

15. The article of claim 14, the instructions for further causing the processor to, in the management controller, if the requirements are unsatisfied, set a power enablement policy for the main power path and the auxiliary power path to enable the information handling resource in only the powered on state of the host system.

16. The article of claim 13, wherein the information handling resource comprises a data processing unit.

17. The article of claim 13, wherein the card cable presence detection signal comprises CARD_CBL_PRES #of the Peripheral Component Interconnect Special Interest Group standard.

18. The article of claim 13, wherein the input/output interface is a System Management Bus input/output expander.
